(19) United States
(12) Patent Application Publication
(10) Pub. No.: US 2019/0000140 A1
(43) Pub. Date: Jan. 3, 2019

(54) Threaded Lid Ashtray combine with Tobacco/Herb Grinder

(71) Applicant: Erik D. Manning, Glendale, CA (US)

(72) Inventor: Erik D. Manning, Glendale, CA (US)

(21) Appl. No.: 16/024,879

(22) Filed: Jul. 1, 2018

Related U.S. Application Data
(60) Provisional application No. 62/488,633, filed on Jul. 1, 2017.

(51) Int. Cl. A24F 19/10; A24F 9/10; A47J 42/34

(52) U.S. Cl. CPC A24F 19/10; A47J 42/34; A24F 9/10

(57) ABSTRACT

The present invention generally relates to improvements in a Ashtray/Debowlers/ Tobacco/ Herb Grinder and more particularly to a aerospace Aluminum Lidded Ashtray/Debowler combine with Tobacco/Herb Grinder. There is a known ashtray/debowler in which has a bowl surface catchers the ashes and resin with a vertical spike mounted in the of the bottom middle of the ashtray. However, because such a conventional ashtray is only made with wood, glass or plastic, a aerospace aluminum ashtray will be the safest means, the latter is not safe and can cause fire hazards.

The present invention discloses a threaded Lid (1) comprising a spike (2), ash catcher (3), upper section of grinder teeth (4) lower section of grinder teeth and (5) storage cavity ground material falls into

### TECHNICAL FIELD

The present invention generally relates to improvements in a Ashtray/Tobacco/Herb Grinder and more particularly to a aerospace aluminum Threaded Lid Ashtray combine with Tobacco/Herb Grinder.

### BACKGROUND ART

There is a known Ashtray in which has a bowl surface catchers the ashes and resin with a vertical spike mounted in the of the bottom middle of the ashtray. However, because such a conventional ash tray is only made with wood, glass or plastic a aerospace aluminum ashtray will be the safest means, the latter is not often safe and can cause fire hazards.

### SUMMARY OF THE INVENTION

An object of the present invention is to provide a Threaded Lid Ashtray combine with Tobacco/Herb Grinder, made of Aluminum.

In accordance with the present invention, there is provided a with removable thread spike comprising: a bored out lid that serves as standard ash trash; a half bowl base with a threading at bottom; the spike is removable for cleaning purposes and can be replaced.

At the end of the same piece the threaded lid, spike and ash catcher base, the first section of the grinder teeth are located on the underside. The second section of the grinder teeth are located on the a separate piece, where you would place your desired material to be ground by inserting the section comprising of the threaded lid, spike and ash catcher base, the first section of the grinder teeth into the second section of teeth.

According to the present invention, when inserting the section comprising of the lid, spike and ash catcher, the first section of the grinder teeth piece into the second section of teeth piece, the teeth will grind material that will fall through the holes, into the bottom storage cavity. Further, according to the present invention, you will turn the bottom side from the threads of the second teeth section that are located above the storage cavity, where all of the ground material is retrieved.

### BRIEF DESCRIPTION OF THE DRAWINGS

FIG. 1 Top is a view illustrates the open lid and spike preferred embodiment of a Threaded Lid Ashtray ;

FIG. 1, 2, 3 illustrate perspective views of a receptacle in embodiments of the present invention.

FIG. 2 is a middle perspective view of the open Tobacco/Herb Grinder;

FIG. 3 is a perspective view from the underside of the Tobacco/Herb Grinder and the storage cavity.

### DETAILED DESCRIPTION OF PREFERRED EMBODIMENTS

The present invention generally relates to improvements in a Ashtray/Debowlers/Tobacco/Herb Grinder and more particularly to a aerospace Aluminum Lidded Ashtray/Debowler combine with Tobacco/Herb Grinder. There is a known ashtray/debowler in which has a bowl surface catchers the ashes and resin with a vertical spike mounted in the of the bottom middle of the ashtray. However, because such a conventional ashtray is only made with wood, glass or plastic, a aerospace aluminum ashtray will be the safest means, the latter is not safe and can cause fire hazards.

The present invention discloses a threaded Lid (1) comprising a spike (2), ash catcher (3), upper section of grinder teeth (4) lower section of grinder teeth and (5) storage cavity ground material falls into.

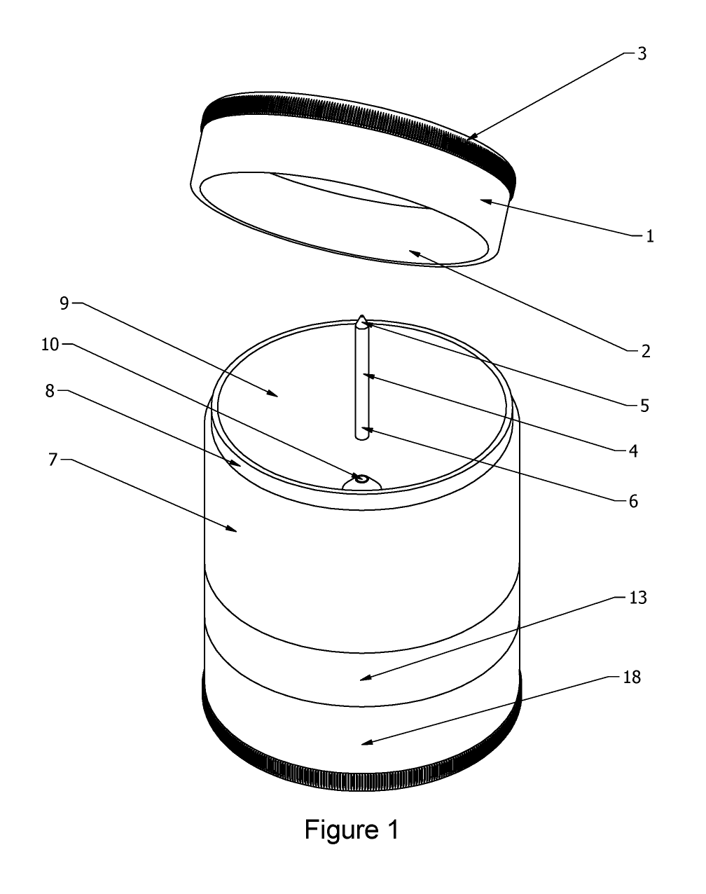

Referring now to the drawings wherein like numerals refer to like parts, In FIG. 1 Threaded Lid 1 Bored out under side that serves as standard ashtray 2 Textured grip 3 removable spike shaft 4 pointed spike tip 5 threaded bottom of spike 6 The removable spike shaft 4 threaded bottom of spike 6 are placed into the threads at the ash catcher bottom 9 spike threading 10 The outer threads 8 that are at the top of the embodiment 7 Thread into the threads of the thread lid 1 when the lid 1 is placed on top of the embodiment 7.

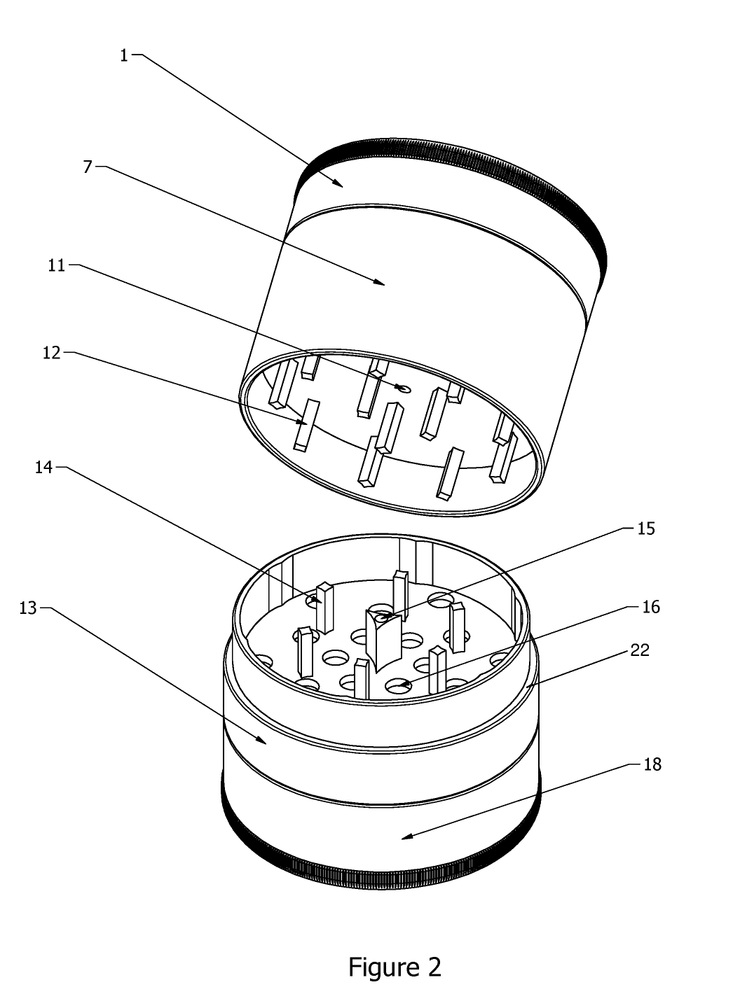

Referring to FIG. 2 Top grinder side Rare earth magnet 11 Top section of grinder teeth 12 Bottom Grinder teeth 14 bottom grinder side rare earth magnet 15 holes for ground material to fall through 16

Referring again to FIG. 2. the Top grinder side Rare earth magnet 11 Top grinder teeth 12 would be inserted into the Bottom grinder teeth 14 bottom grinder side rare earth magnet 15 holes for ground material to fall through 16 after material has been placed around bottom grinder teeth. The Grinder friction ring 22 is between the Top embodiment 7 and Bottom embodiment 13 to keep grinder from creating friction and moving smoothly

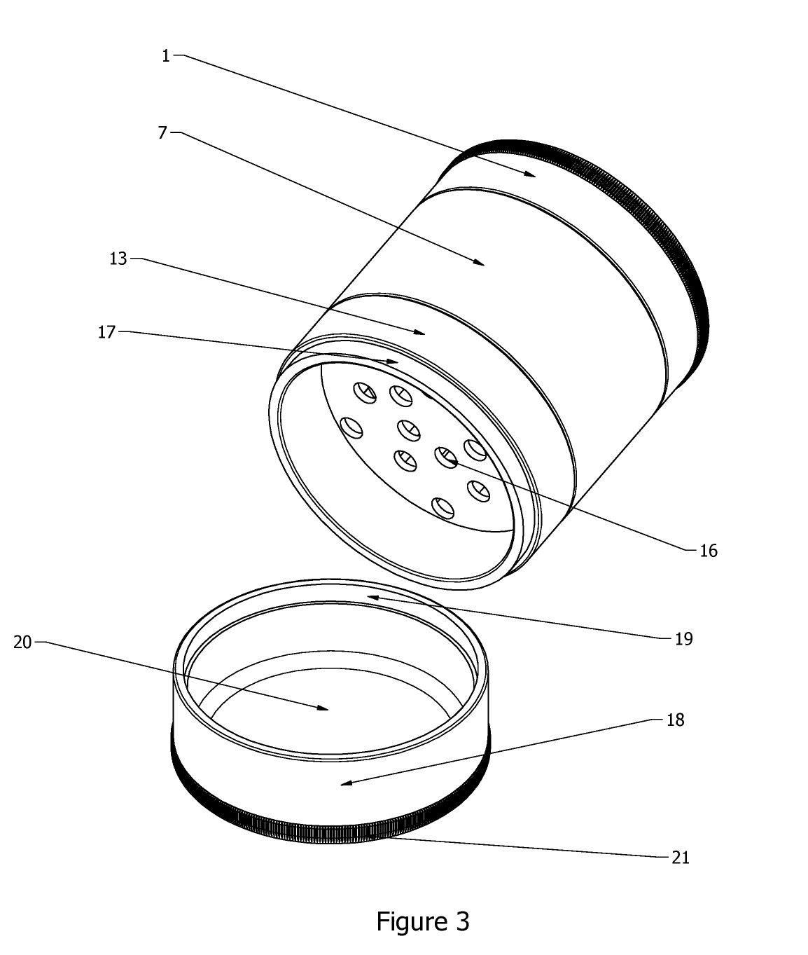

As shown in FIG. 3. the threaded bottom of the grinder 17 untreard from the storage cavity threads 19 to the storage cavity 20 once you have removed the material from the storage cavity 20 it can be replace the bottom of the grinder 17 on top of the storage cavity embodiment 18 of the storage cavity threads 19 and twist back with textured grip to close.

1. This 5 piece herb grinder was designed to keep your hands clean, whole tobacco/herbs ground, and your herb/tobacco ash and resin cleaned without any mess. 5 piece Threaded Lid Ashtray combine with Tobacco/Herb Grinder made of aerospace aluminum: Piece 1: Lid to keep all residual herb and smell contained and serves as a regular ashtray. Piece 2: Removable threaded spike that can be replaced, to scrape out with remaining ashes from tobacco or herb pieces. Piece 3: The top half of piece 3 serves the ash catcher from the rements and place where spike can be thread into place at the center of the base of the ashcatcher. The underside of piece 3 is first side of the grinder teeth that fit into piece 4 that is the for the tobacco/herb. Piece 4 : This piece also contains aluminum teeth and holes for herb to fall into piece 5. They will join together with the aluminum teeth on the underside of piece 3. Once the herbs are in place, replace with the lid and grind and pulverize your herbs by twisting the lid. Piece 5: Storage container where the ground Tobacco/Herb will fall into through the holes from piece 4. All pieces are threaded together to complete Lidded Ashtray/Debowler with Tobacco/Herb Grinder.
